(19) United States
(12) Patent Application Publication
(10) Pub. No.: US 2004/0064196 A1
(43) Pub. Date: Apr. 1, 2004

(54) Network management equipment for creating policy data to be set to the configuration elements constituting a communication network system

(76) Inventors: Tomoyuki Furutono, Fukuoka (JP); Kyoko Ichibangase, Fukuoka (JP); katsuichi Nakamura, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/622,085

(22) Filed: Jul. 17, 2003

(30) Foreign Application Priority Data
Jul. 19, 2002 (JP) 2002-210811

(51) Int. Cl. G05B 15/00

(52) U.S. Cl. 700/1

(57) ABSTRACT

Network management equipment creates policy data to be set to a configuration element in a communication network system. The Network management equipment includes an input section for inputting a network resource required for a network service, which is provided through the communication network system in the form of real entity in a service equivalent to said network service being provided without using the communication network system; and a conversion section for converting to the network resource the real entity input from the input section, and creating policy data based on said network resource.

### FIELD OF THE INVENTION

The present invention relates to network management equipment and a network management method, and more particularly network management equipment and a network management method for creating policy data to be set to the configuration elements constituting a communication network system.

### BACKGROUND OF THE INVENTION

In recent years, broadband access interfaces (access lines) such as ADSL (Asymmetric Digital Subscriber Line) and FTTH (Fiber To The Home) have been widespread in use. With this trend, there has been an increased demand for broadband information providing services using the Internet, in particular content distribution services represented by streaming services of moving images.

Such content distribution service has the following features: (1) Relatively large bandwidth (several Mbps) is required. (2) The bandwidth is continuously in use for a certain time (two to three hours in case of relaying a concert), although the bandwidth may vary from time to time when the VBR (Variable Bit Rate) communication is optimally applied. (3) Required network resources such as bandwidth differ depending on the quality of content desired by the viewers.

To enable such content distribution service, the following are necessary; (a) ensuring a certain level of QoS (Quality of Service), (b) ensuring network resources such as bandwidth for a certain time period, (c) calculating a necessary amount of the network resources, (d) assigning and setting the network resources optimally on the communication network, and (e) providing the QoS level desired by each viewer.

For these purposes, the following are typically required for each service provider: (A) determining an optimal path from a content server to each viewer in the communication network, (B) setting QoS levels into the routers in the communication network, (C) determining an optimal content server corresponding to each viewer (taking the server load into consideration), (D) selecting a suitable path, and setting the QoS, corresponding to the quality requested by each viewer.

Here, a policy server is provided for setting the above-mentioned network resources. The policy server is a network management server having functions such as collectively setting QoS into a plurality of configuration elements (routers, servers, etc.) in the communication network. For example, the policy server performs end-to-end bandwidth acquisition. Using the policy server, it becomes unnecessary to set policy data separately to the configuration elements in the communication network, and accordingly QoS guarantee such as ensuring the end-to-end bandwidth becomes obtainable in a simple manner.

Here, the term ‘policy’ denotes a setting guide for bandwidth acquisition or path selection in each configuration element of the communication network. The aforementioned items (a)-(e) are typical examples of the policies managed and controlled by the policy server. By distributing to the network resources the aforementioned items (a)-(e) as the policies, it becomes possible to obtain an efficient and stable communication network operation, ensuring the required QoS level.

Generally, in the policy server, an input man-machine interface such as GUI (Graphical User Interface) is attached. Through this input man-machine interface, a network administrator can register policies by perceiving connection conditions of the configuration elements, unused bandwidths in the communication network, etc., and can instruct (distribute) the network resource settings related to bandwidth acquisition, path control, etc. to the configuration elements In the communication network. At present, network experts and operators in charge of communication network management and operation establish and distribute the policies to obtain efficient and stable communication network operation, which requires a large amount of operation costs.

Meanwhile, there are known protocols such as RSVP (Resource Reservation Protocol) and Diff-SerV (Differentiated Services) for bandwidth guarantee and path control on an IP packet-by-packet basis (i.e. on a basis of either source/destination IP address or port number). However, these are the means for ensuring QoS on a protocol basis against the setting requests from the policy server, instead of for independent use in the network management. In this sense, these protocol means may be categorized in the network operation performed in the policy server.

In the conventional method, there are problems described below: First, when performing the aforementioned items (a) to (e) by use of the GUI attached in the conventional policy server, it is necessary to set policies separately for each viewer in the worst case.

When using the conventional method, it is quite troublesome for the service provider or the network operator to set, manage and operate the communication network, because a VOD (Video On Demand) and a content distribution such as live relay are being served almost daily. Moreover, the time necessary for setting these data is not negligible, and the costs including labor cost become large.

In addition, using the GUI adopted in the conventional policy server, it is necessary to grasp the conditions of network resources, server performance, etc., which are intuitively not easy to perceive, and set, manage and operate the communication network to satisfy the desired quality of service to each viewer. Therefore, for the staff in the service providers who are generally not network experts, it is not easy to establish and distribute the policies.

Also, when using protocols such as RSVP and Diff-Serv, setting into the routers is essentially needed, and therefore, a problem similar to the case of using the policy server arises. The present invention has been invented on such background as described above.

### SUMMARY OF THE INVENTION

It is an object of the present invention to provide network management equipment and a network management method capable of easy setting, management, etc. of a communication network system.

In order to attain the above-mentioned object, according to the present invention, there is disclosed network management equipment which creates policy data for setting into the configuration elements of the communication network system. The network management equipment includes an input section capable of inputting a network resource required for a network service provided through the communication network system in the form of real entity in a service equivalent to the above-mentioned network service being provided without using the communication network system. The network management equipment also includes a conversion section converting the real entity input from the input section to the network resource, and creating the policy data based on the network resource.

According to the present invention, there is also disclosed a network management method for creating policy data to be set to the configuration elements in a communication network system. The network management method includes; providing a service provider and a user receiving a network service with man-machine interface capable of inputting the network resource required for providing, or receiving, the network service through the communication network system in the form of real entity in a service equivalent to the above-mentioned network service being provided without using the communication network system; converting the real entity having been input through the man-machine interface to the network resource; and creating the policy data for use in a policy server based on the network resource.

According to the present invention, a network resource required for providing a network service through a communication network system can be input in the form of real entity in a service equivalent to the network service being provided without using the communication network system. Therefore, service providers and users who receive services can perform communication network setting and management in the form of real entities which are intuitively easy to grasp. This enables easy setting and management of the communication network.

By way of example, the aforementioned network service includes content distribution service. Also, the aforementioned network resource includes a bandwidth required for providing the service. Further, the aforementioned real entities include a seat in the venue where the service content is directly viewed. Each rank of the seats corresponds to the aforementioned bandwidth size required for providing the service.

Further scopes and features of the present invention will become more apparent by the following description of the embodiments with the accompanied drawings.

### BRIEF DESCRIPTION OF THE DRAWINGS

FIG. 1 shows an exemplary configuration block diagram of a communication network system in accordance with an embodiment of the present invention.

FIG. 2 shows an example of path information retained in a policy server.

FIG. 3 shows a functional block diagram illustrating a conversion server configuration.

FIG. 4 shows a registration screen of the man-machine interface for service registration.

FIG. 5 shows a registration screen of the man-machine interface for service registration FIG. 6 shows a registration screen of the man-machine interface for service registration.

FIG. 7 shows an example of content information.

FIG. 8 shows a service content modification screen of the man-machine interface for service reservation

FIG. 9 shows a service content modification screen of the man-machine interface for service reservation.

FIG. 10 shows a service content modification screen of the man-machine interface for service reservation.

FIG. 11 shows a service reservation screen of the man-machine interface for service reservation.

FIG. 12 shows a service reservation screen of the man-machine interface for service reservation.

FIG. 13 shows a service reservation screen of the man-machine interface for service reservation.

FIG. 14 shows an example of viewer information.

FIG. 15 shows a flowchart illustrating a processing flow for converting content information and viewer information into policy data.

FIG. 16 shows an example of ‘real entity versus bandwidth’ information.

FIG. 17 shows an example of policy data.

FIG. 18 shows a view start screen.

FIG. 19 shows a view start screen.

### DETAILED DESCRIPTION OF THE PREFERRED EMBODIMENTS

The preferred embodiment of the present invention is described hereinafter referring to the charts and drawings. In the following description, content distribution service is illustrated as one example of the network services using a communication network.

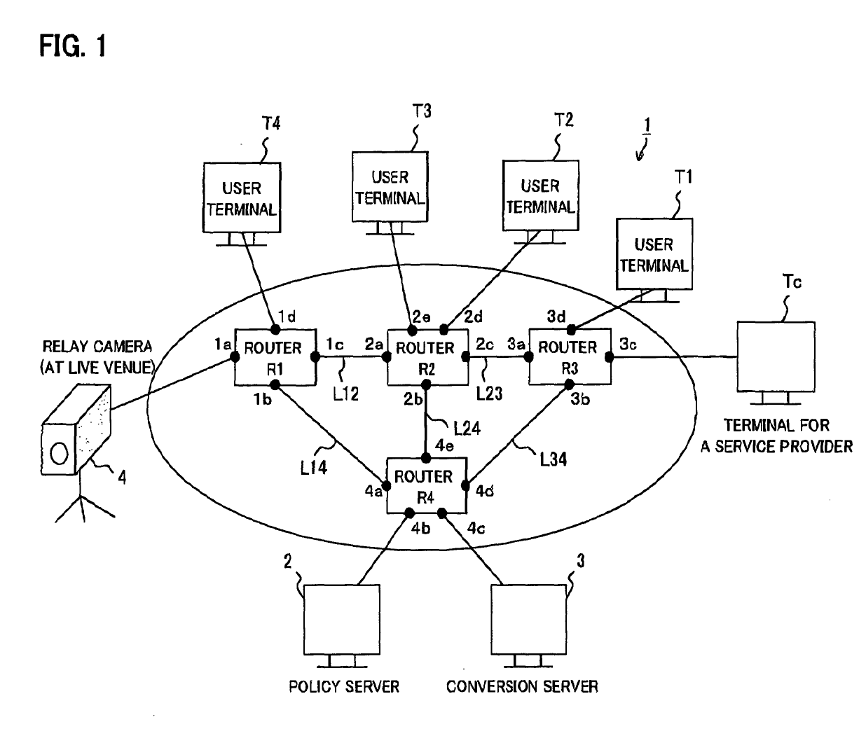

FIG. 1 shows an exemplary configuration block diagram of a communication network system in accordance with an embodiment of the present invention. This communication network system 1 exemplarily includes the Internet, and is constituted of a plurality of routers (by way of example, four routers R1-R4 are shown in FIG. 1) as exemplary configuration elements of the communication network system, a plurality of user terminals (by way of example, four user terminals T1-T4 are shown in FIG. 1), a terminal Tc for a service provider, a policy server 2, and a conversion server 3.

User terminals T1-T4 are the terminals used by the users (viewers) receiving content distribution services. Terminal Tc for the service provider is the terminal used by the provider of content distribution service. Each user terminal T1-T4, as well as terminal Tc for the service provider, is constituted of a computer such as a personal computer.

To router R1, a relay camera 4 installed in a live venue (concert venue) is connected so as to provide a live broadcast service of the concert distributed through the network. Or, differently, a content server (not shown in the figure) owned by the service provider is connected to router R1. Relay camera 4 is connected to this content server.

Router R1 has ports 1a-1d, router R2 has ports 2a-2d, router R3 has ports 3a-3d, and router R4 has ports 4a-4d, respectively. Links L12, L23, L24 and L34 connecting between the routers and the ports connected to these links have a bandwidth of 1 Gbps, whilst a link L14 and the port connected to this link L14 has a bandwidth of 100 Mbps.

Policy server 2 retains each path information set from an incoming port of each router to an outgoing port of other router. Accordingly, the path information sets contain path information from relay camera 4 to user terminals T1-T4. This path information is obtained in the following way. A network administrator or the like inputs to policy server 2 the information of the routers installed in communication network system 1, the ports provided in each router, the bandwidths of each port, etc., which is retrieved by policy server 2 using a routing protocol such as OSPF (Open Shortest Path First). From an incoming port of one router to an outgoing port of another router, a predetermined number of paths (for example, 4, 5, etc.) are retrieved.

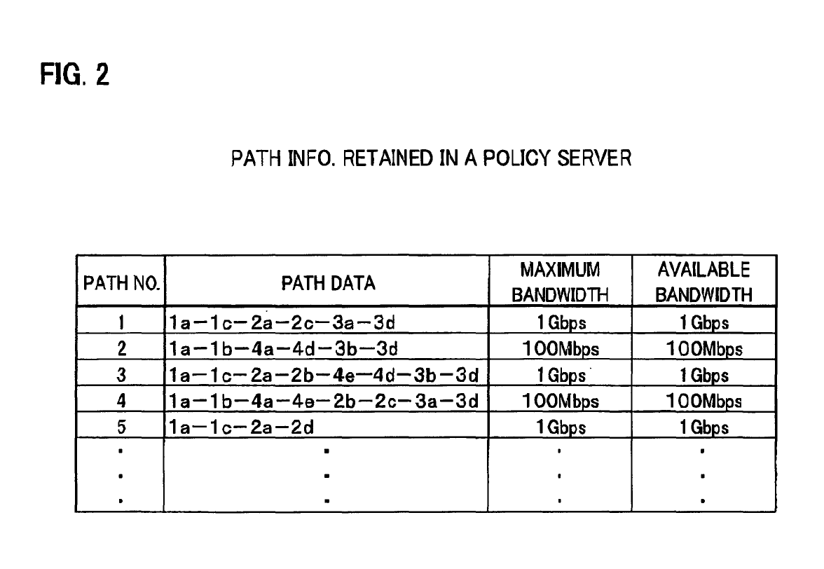

FIG. 2 shows an example of the path information retained in policy server 2. The path information has the following data items: Path number, path data, maximum bandwidth, and available bandwidth.

‘Path number’ is a serial number assigned to each path, which can be used as an identification number for uniquely identifying each path.

‘Path data’ is a data representing a path from an incoming port of one router to an outgoing port of another router, which is shown as a string (port string) of port identifiers (symbols 1a, 2b, 3c, etc.) of each router connected along the path concerned. In FIG. 2, as an example, there are shown four sets of the path data representing the paths from port 1a connecting relay camera 4 to port 3d connecting user terminal T1. Also, a part of the path data from port 1a to port 2d connecting user terminal T2 is shown.

‘Maximum bandwidth’ is the maximum bandwidth available in each path, in which a minimum bandwidth among the bandwidths of links (ports) constituting each path is set. For example, each link L12, L23 constituting the path having path number 1 (path #1) has a bandwidth of 1 Gbps. Accordingly, the maximum bandwidth of this path is 1 Gbps. Meanwhile, among the links constituting the path having path number 2 (path #2), i.e. link L14 and link L34, the bandwidth of link L14 is 100 Mbps, while the bandwidth of link L34 is 1 Gbps. Therefore, the maximum bandwidth of this path equals to 100 Mbps.

‘Available bandwidth’ denotes the bandwidth currently available in the maximum bandwidth. The value of this available bandwidth is obtained by subtracting, from the maximum bandwidth, the bandwidth used in a command (described later) when the command is issued from conversion server 3 to policy server 2. For example, when the command is issued against the path #1 to set a path having a bandwidth of 6 Mbps, the available bandwidth of the path #1 is changed to 994 Mbps (=1 Gbps-6 Mbps) The path information shown in FIG. 2 represent the values before the command was issued, and therefore each available bandwidth has the same value as each maximum bandwidth.

Additionally, in policy server 2, there are stored the addresses (IP addresses) of the entire routers existent in communication network system 1 (i.e. routes R1-R4 shown in FIG. 1), and the port addresses (IP addresses) or each router.

Conversion server 3 is one example of network management equipment, or a portion thereof, in which a man-machine interface for service input is provided. Through this interface, network resources necessary for providing a network service can be input in the form of real entities. The data fed through the man-machine interface for service input are converted into the policies which can be used in policy server 2.

Here, ‘network resources necessary for providing a network service’ include, as an example, a bandwidth which is allocated to any content to be distributed in content distribution service. Also, ‘real entities’ are the real entities employed in a service equivalent to the network service concerned, assuming that the service is provided without using a communication network. By way of example, when the network service is distribution service of a live concert or a movie, holding the live concert or running the movie corresponds to the service provided without using the communication network. Accordingly, the real entities in such a case are; concert venue or movie house, rank of the seats in the concert venue or the movie house (seat S, seat A, seat B, etc.), the number of the seats prepared, etc.

Namely, the man-machine interface for service input is used to map the necessary network resources for providing the network service into the real entities, and to provide (display) the information on the mapped real entities to the service provider and the viewers. Using this man-machine interface for service input, the service provider and the viewers having little expertise on communication network can easily input the information necessary for setting the communication network, and set the communication network.

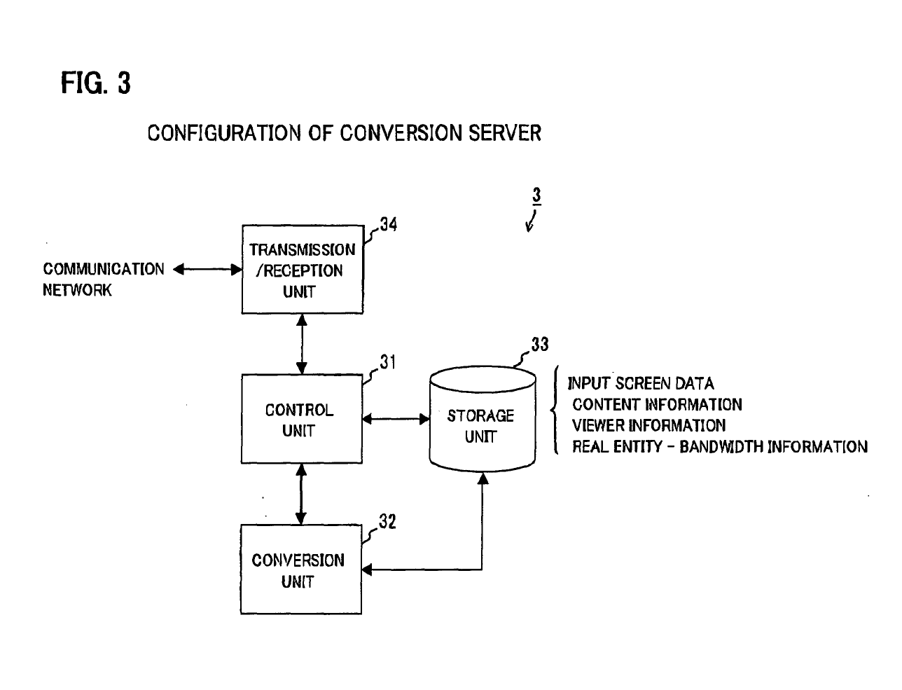

FIG. 3 shows a functional block diagram illustrating the configuration of conversion server 3. Conversion server 3 is constituted of control unit 31, conversion unit 32, storage unit 33, and transmission/reception unit 34.

Control unit 31 controls conversion unit 32 and transmission/reception unit 34. Transmission/reception unit 34 performs interface processing (protocol processing etc.) for transmitting/receiving data (input screen data, policy, etc. described later) through the communication network.

Storage unit 33 stores input screen data of the man-machine interface for service input, view start screen data, information related to the contents of the content distribution service (referred to as content information), information related to each viewer receiving the content distribution service (viewer information), information indicative of the relation between the real entities and the bandwidth (‘real entity versus bandwidth’ information), etc.

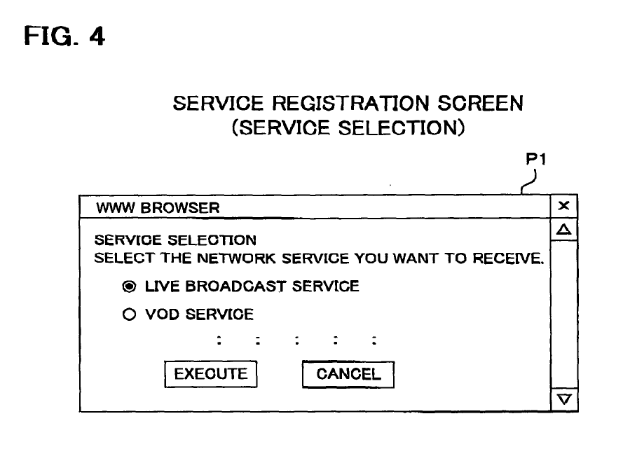

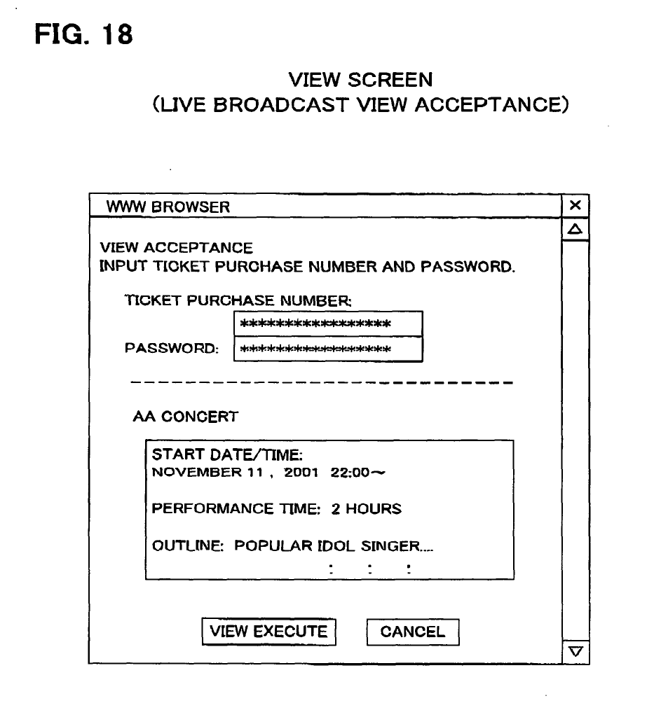

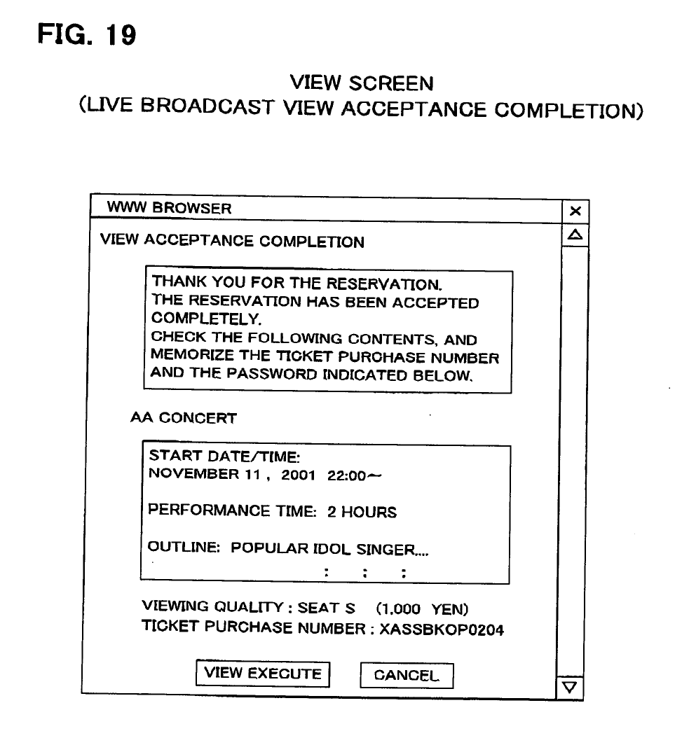

The input screen data (refer to FIGS. 4-6 and FIGS. 8-13 explained later), view start screen (refer to FIGS. 18, 19 also explained later), and the real entity versus bandwidth information are created in advance, and are stored in storage unit 33. Also, the content information is created by control unit 31 based on the data input from the service provider through the man-machine interface for service input. The viewer information is created by control unit 31 based on the data input from the viewer through the man-machine interface for service input. The details of these data and information will be described later.

Conversion unit 32 converts the data and the information stored in storage unit 33 into policy data. The converted policy data are transmitted to policy server 2 via transmission/reception unit 34 under the control of control unit 31.

The man-machine interface for service input includes a man-machine interface for service registration, through which the service provider registers the content distribution service to be provided, and a man-machine interface for service reservation, through which each viewer makes reservation (subscription) of the provided service. The man-machine interface for service registration is prepared in a Web page of conversion server 3, which can be accessed by specifying the URL for service reservation.

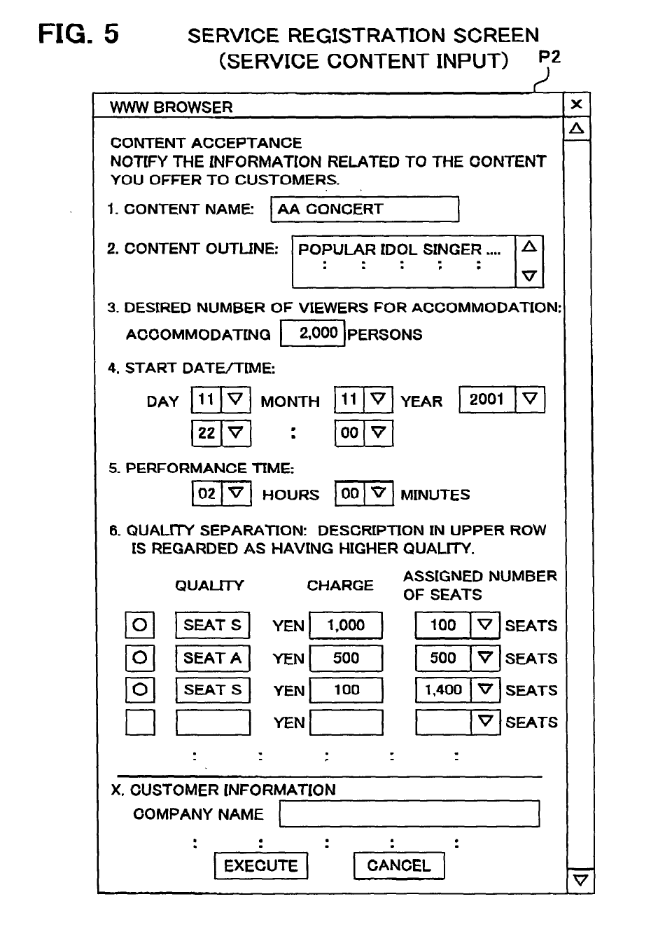

FIGS. 4 through 6 depict the service registration screens (windows) of the man-machine interface for service registration FIG. 4 is a service selection screen, FIG. 5 is a service content input screen, and FIG. 6 is a service registration completion screen. In these figures, there are shown the screens for a live concert distribution service as an example of content distribution services, as mentioned earlier.

When the service provider Initiates a browser (web browser, WWW browser) on terminal Tc for the service provider, and makes an access to the home page for service registration of conversion server 3 by inputting the URL of conversion server 3 for service registration, control unit 31 in conversion server 3 transmits a service selection screen P1 (shown in FIG. 4) stored in storage unit 33 to terminal Tc. The browser installed in terminal Tc displays the service selection screen P1 onto the display unit of terminal Tc.

In the service selection screen P1, a variety of network services (content distribution services) are displayed, In FIG. 4, as an example, there are displayed a live broadcast service and a VOD (Video On Demand) service. The service provider can click on one of the services displayed for selection (hereafter referred to as ‘click and select’) using the input device (pointing device) such as a mouse. In the example shown in FIG. 4, the live broadcast service is clicked and selected.

After a network service is selected, when the service provider clicks and selects the execution button displayed on the lower part of the screen, terminal Tc transmits data indicative of the selected service to conversion server 3. Control unit 31 in conversion server 3 then transmits to terminal Tc a service content input screen P2 (shown in FIG. 5) which is provided corresponding to the selected service. The browser in terminal Tc then displays the service content input screen P2 onto the display unit.

The service content input screen P2 has input fields for content name, content outline, desired number of viewers for accommodation, start date/time, presentation time, quality separation (classification), name (company name) of the service provider, etc. In addition, though not shown in the figure, there are prepared input fields for physical connection information, the period for collecting the viewers, the location (address or residence) of the service provider (company), a telephone number, a name of the representative, a telephone number of the staff in charge, a mail address of the staff in charge, a URL of the reservation screen for viewers (hereafter referred to as ‘reservation screen URL for viewers’), and a URL of the screen for viewing (hereafter referred to as ‘view screen URL’). The service provider inputs necessary items into these input fields.

The input field ‘Content name’ is prepared as an input field for inputting the name of the content assigned by the service provider. In this example, the name ‘AA concert’ has been input. The input field ‘Content outline’ is afield for inputting the content outline offered by the service provider to the viewers.

The input field ‘Desired number of viewers for accommodation’ is prepared for inputting the desired number of viewers (number of viewers to be admitted) who can view the concert through the communication network. In this example, a number 2,000 has been input. The input field ‘Start date/time’ is a field for inputting the start date/time of the live broadcast, and the input field ‘Presentation time’ is for inputting the broadcast time of the live broadcast.

The field ‘Quality separation’ is prepared for inputting the way of live broadcast presentation classified from the duality viewpoint. In FIG. 5, there are provided input fields of ‘quality name’, ‘charge’, and ‘prepared number of seats (prepared seats)’.

The input field ‘Quality name’ is prepared for inputting the bandwidth which is to be specified as one of the network resources necessary for providing the live broadcast service. The bandwidth data is input in the form of real entity i.e. rank of the seats in the concert venue. In FIG. 5, the quality corresponding to the bandwidth is classified into three ranks: ‘Seat S’, ‘Seat A’ and ‘Seat B’ are input by the service provider in order of better quality. Also, the service provider can input the charge for each seat and the number of prepared seats, corresponding to the real entity of the seats.

As such, bandwidth necessary for providing the live broadcast service is mapped to real entity in the concert venue, and can be input in the form of real entity. Accordingly, even a service provider who has little expertise of network can easily register the service.

Here, the names of the seats which can be input in the input field, such as seat S, seat A, etc., are informed in advance to the service provider through a usage manual, etc. Or, otherwise, the service provider can find out the implication of these names by use of non-illustrated HELP function, pop-up menu, pull down menu, etc. Similarly, the service provider can perceive in advance the quality level corresponding to each seat such as class S, class A (for example, each quality level represented by the relation of correspondence such that the seat S corresponds to the screen image quality equivalent to the quality of the high-density television, and that the seat A corresponds to the quality equivalent to the normal television), or the bandwidth corresponding to each seat.

The input field ‘Company name’ is prepared for inputting the company name of the service provider (service provider name).

After fulfilling these input items, the service provider clicks and selects the execution button provided in the lower part of the service content input screen P2, and the terminal Tc transmits to conversion server 3 the data having been input in the fields of the service content input screen P2.

Control unit 31 in conversion server 3 receives these input data, and then transmits to terminal Tc a service registration completion screen P3 (shown in FIG. 6) which includes the input data and a password. The browser in terminal Tc displays the service registration completion screen P3 onto the display unit. Here, conversion server 3 issues the password to authenticate the service provider registering this service. As will be mentioned later, the password may be used, for example, when the service content is to be modified.

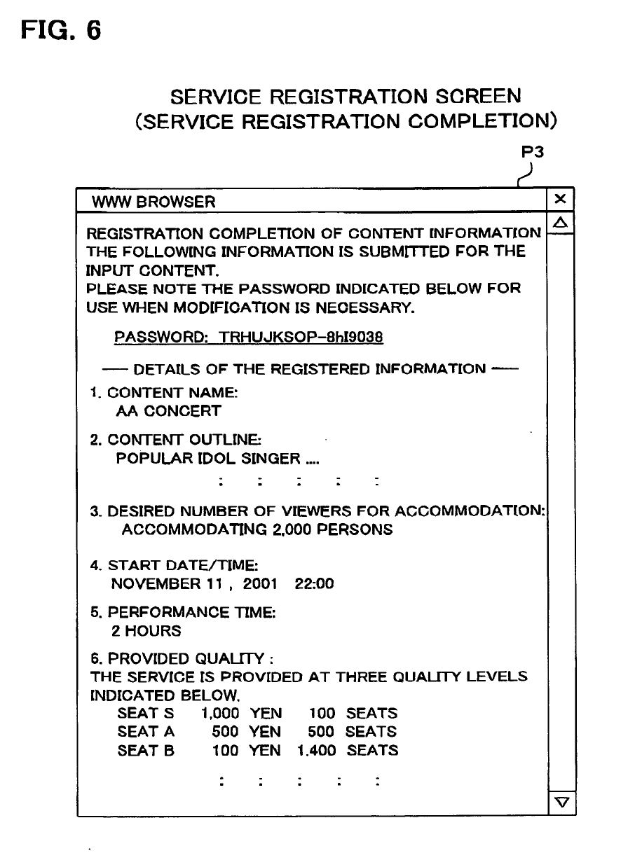

Also, control unit 31 in conversion server 3 creates content information based on the data input into the service content input screen P2, and stores the created content information into storage unit 33. FIG. 7 shows an example of the content information.

In this FIG. 7, ‘Content ID’ is an identifier given to the content information by control unit 31 of conversion server 3 for the purpose of uniquely identifying the content which has been registered through the service registration screen P2. Respective network service contents registered by various service providers can be identified using this content ID.

‘Viewer ID group’ includes one or more viewer IDs. ‘Viewer ID’ is an identifier for uniquely identifying each viewer who has subscribed the content distribution service using the man-machine interface for service reservation. The generated numbers of viewer IDs equal to the number of viewers having been subscribed.

Each item from ‘Content name’ to ‘View screen URL’ corresponds to the data input by the service provider using the service registration screen P1 (FIG. 4).

Here, ‘Physical connection information’ is constituted of the identifiers of the router connecting relay camera 4 and the connection port in the router concerned. Also, ‘Reservation screen URL for viewers’ is the URL for service reservation mentioned earlier, which is used when a viewer makes the reservation for the live broadcast from the user terminal. ‘View screen URL’ is the URL which the viewer who completed the reservation of the view inputs to the user terminal when the viewer wants to start viewing the live broadcast. Both URLs are designated by the service provider, or have been prepared in conversion server 3 beforehand. These two URLs may be identical, or different. These URLs may be obtained by use of a retrieval service provided in communication network system 1, or from a magazine, etc.

When the service content is to be modified after registering the service, the service provider can modify the service content using a service content modification screen provided in the man-machine interface for service registration in conversion server 3.

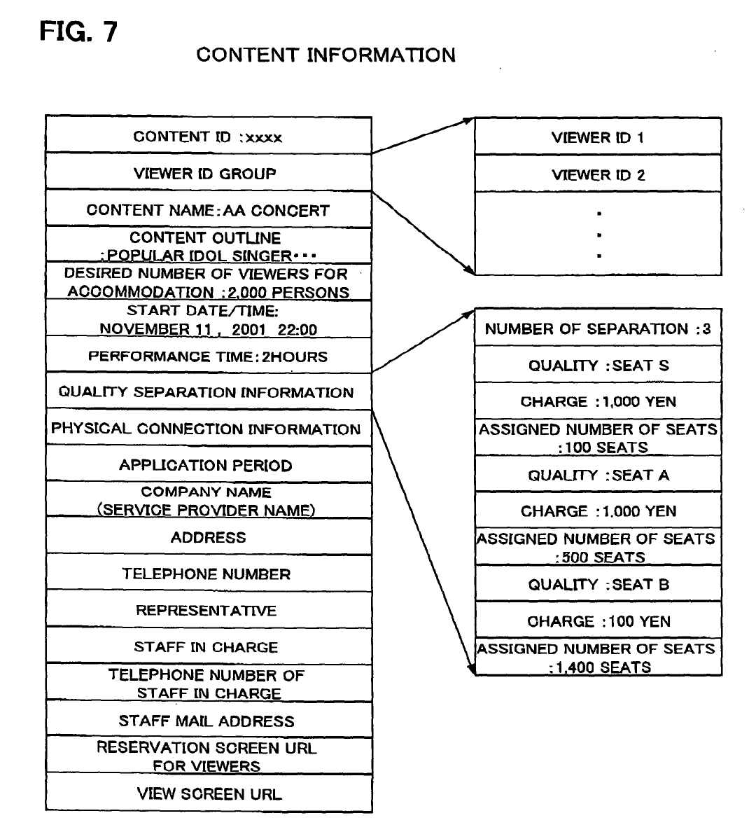

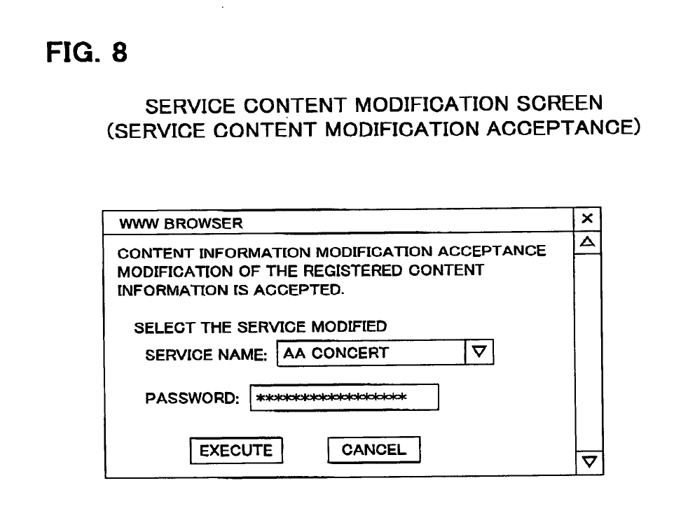

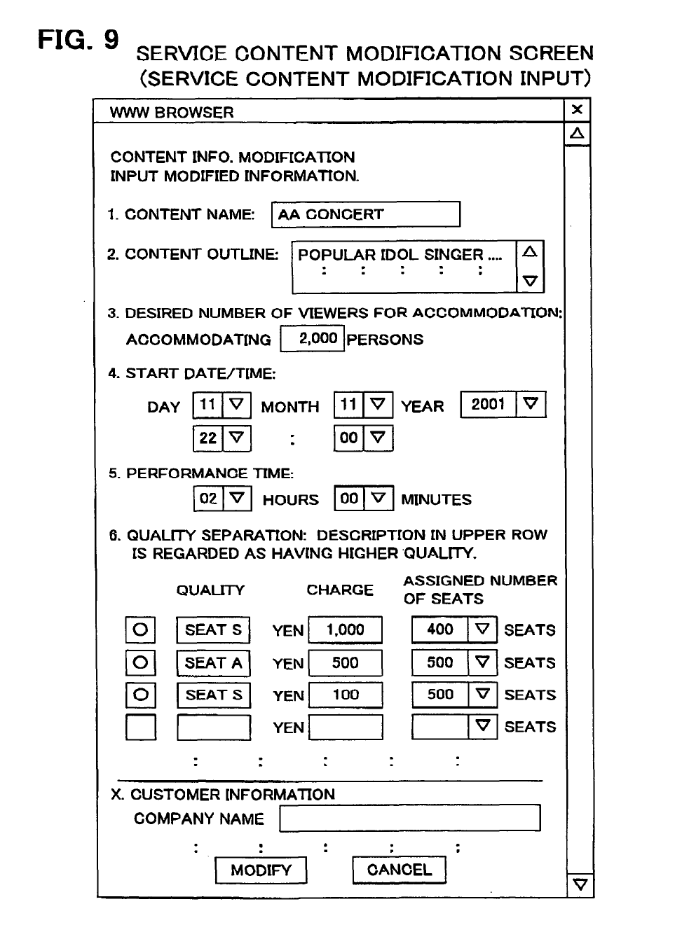

FIGS. 8 through 10 show the service content modification screen in the man-machine interface for service registration. FIG. 8 shows a service content modification acceptance screen, FIG. 9 shows a service content modification input screen, and FIG. 10 shows a service content modification completion screen.

The service provider inputs the service name (content name) and the password displayed on the service registration completion screen P3 shown in FIG. 6 using the service content modification acceptance screen (FIG. 8) displayed on the display unit of terminal Tc. Thereafter, when the service provider clicks and selects the execution button, conversion server 3 transmits to terminal Tc the service content modification input screen (FIG. 9) corresponding to the service name and the password having been input.

In this service content modification screen, the service content having been registered using the service content input screen shown in FIG. 5 is displayed. The service provider can modify one or more items of this content. In the example shown in FIG. 9, the number of the prepared seats for the seat S has been modified from 100 seats to 400 seats, and also the number of the prepared seats for the seat B has been modified from 1400 seats to 500 seats, as can be understood by comparing FIG. 9 with FIG. 5. In such a way, because network resources necessary for providing the service are mapped into real entities, the service provider can modify the service content in the form of the real entities.

When the modification button provided in the lower part of the screen is clicked and selected after the modification input is completed, the service content modification completion screen (FIG. 10) is displayed, and thus the modification is completed. Along with this, control unit 31 in conversion server 3 changes the content information having been stored in storage unit 33 in accordance with the modification content input by the service provider.

After the content distribution service is registered, it becomes possible for a viewer (user) to reserve the provision of the service having been registered. The viewer makes this reservation by accessing the Web page of conversion server 3, which is designated by the reservation screen URL for viewers through the man-machine interface for service reservation.

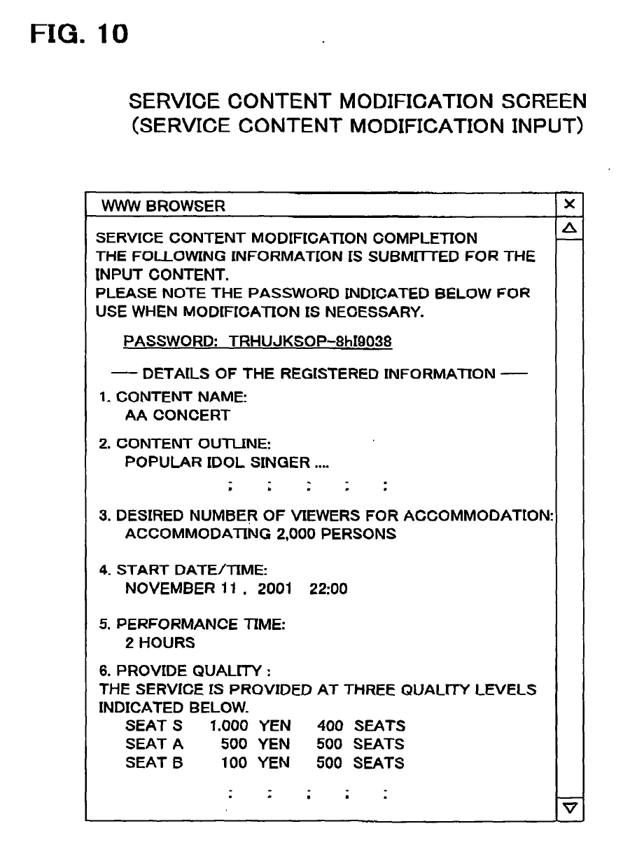

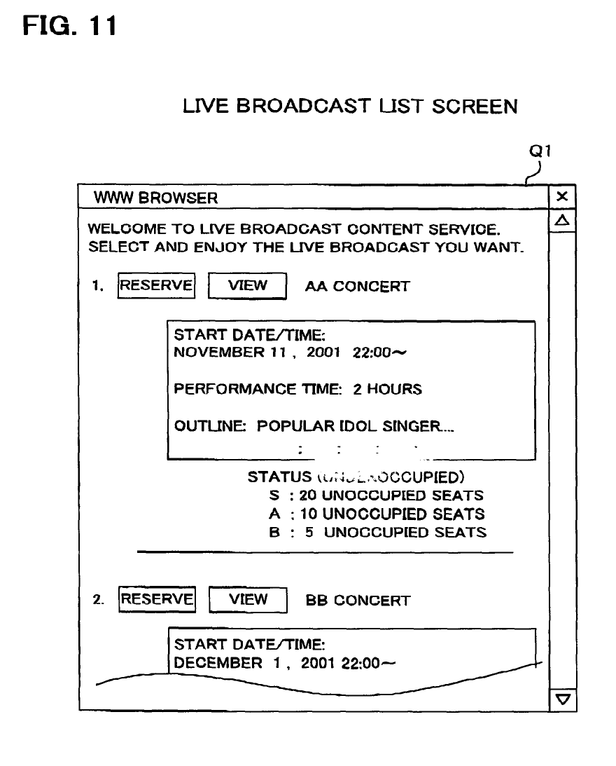

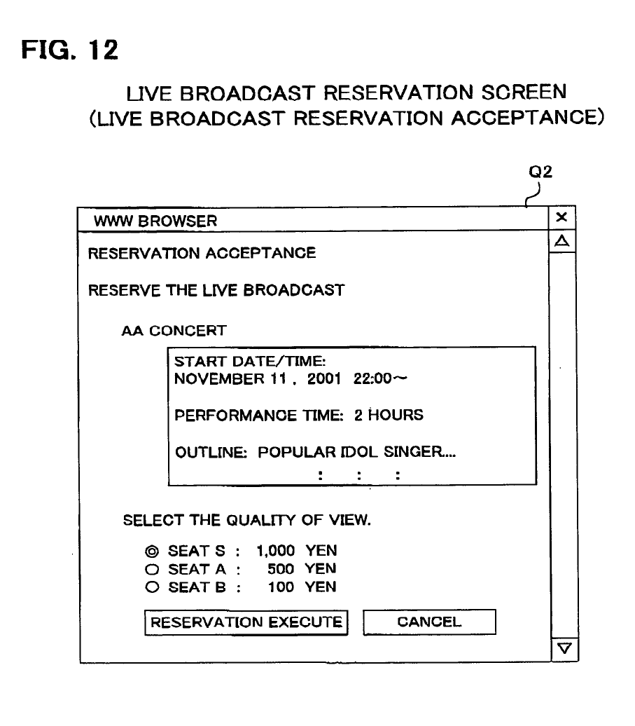

FIGS. 11 through 13 show the service reservation screens (windows) in the man-machine interface for service reservation. FIG. 11 shows a live broadcast list screen, FIG. 12 shows a live broadcast reservation acceptance screen, and FIG. 13 shows a live broadcast reservation completion screen, respectively.

When the viewer initiates the browser using one of the user terminals (assumed as user terminal T1), inputs into this browser the reservation screen URL for viewers, and accesses the Web page of conversion server 3 for network service reservation, control unit 31 of conversion server 3 transmits a live broadcast list display screen Q1 (FIG. 11) to user terminal T1. The browser in user terminal T1 displays the live broadcast list display screen Q1 onto the display unit of user terminal T1.

In this live broadcast list display screen Q1, one or more live broadcasts having been registered using the aforementioned service registration screen are displayed. In each part corresponding to each live broadcast, a current reservation status is displayed together with the start date/time, the presentation time, and the content outline which are included in the content information (shown in FIG. 7).

In the field of ‘Current reservation status’, there are written a value calculated by control unit 31 in conversion server 3, which is obtained from the number of seats prepared in each rank of the seats described in the content information, the number of viewer ID groups registered, and viewer information which will be explained later. For example, assuming 100 for the number of the prepared seats for the seat S indicated in the content information, if the number of viewers having subscribed for the seat S is 80, which is obtained from the viewer IDs in the viewer ID group and the viewer information, then the number of the unoccupied seats equals to 20.

Among the displayed live broadcasts, by clicking and selecting the reservation button for the live broadcast (concert) the viewer wants to view, the viewer can reserve this clicked and selected concert.

Here, it is assumed that the reservation button for ‘1. AA concert’ is clicked and selected. As a result of clicking and selecting this reservation button, control unit 31 in conversion server 3 transmits a live broadcast reservation acceptance screen Q2 (FIG. 12) to user terminal T1. The browser in user terminal T1 then displays the live broadcast reservation acceptance screen Q2 onto the display unit.

In this live broadcast reservation acceptance screen Q2, start date/time, presentation time (concert time), outline, etc. included in the content information are displayed. Also, based on the quality separation information included in the content information, the quality (image quality) selection field is displayed together with the charge. This quality selection field is mapped into the seat, which is a real entity of the concert, and displayed. The user can click and select one of these items. In FIG. 12, the seat S is clicked and selected.

As can be understood from the above description, also in case of the service reservation performed by the viewers, the network resources necessary for providing the live broadcast service are mapped to the seats, i.e. the real entities in the concert venue, and displayed in the form of the real entities. Therefore, a viewer having little expertise of network can select and reserve a seat in the same manner as in purchasing an actual ticket for a concert venue.

Additionally, by use of the non-illustrated HELP function, pop-up menu, pull down menu, etc., the viewer can examine each quality level corresponding to each seat S, A, etc. (here, as an example, each quality level is represented by the relation of correspondence such as the corresponding to the screen image quality equivalent to the high-density television, and the seat A corresponding to the quality equivalent to the normal television.)

After selecting the seat, when the viewer clicks and selects the reservation execution button provided in the lower part of the screen, the selected seat information is transmitted to conversion server 3. On receipt of this information, control unit 31 in conversion server 3 transmits a live broadcast reservation completion screen Q3 (FIG. 13) to user terminal T1. The browser in user terminal T1 displays the live broadcast reservation completion screen Q3 onto the display unit.

In this live broadcast reservation completion screen Q3, there are displayed the information notifying the viewer of the completion of reservation, the content of the reserved concert, the details of the reserved seat, and the password.

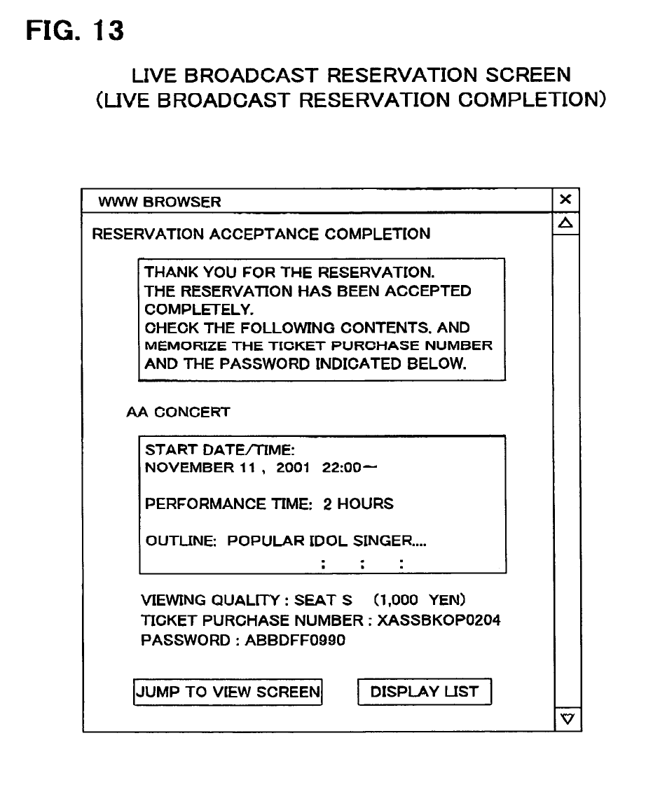

Also, on receipt of the reservation content, conversion server 3 creates viewer information (user information) based on the received reservation content, and stores the created viewer information (user information) into the storage unit. FIG. 14 shows an example of the viewer information.

The viewer information includes content ID, user ID, password, physical connection information, IP address, requested seat, ticket purchase number, and password proper to the ticket purchase number.

‘Content ID’ is identical to the aforementioned content ID in the content information. With this content ID, the content information is linked to the viewer information. ‘User ID’ and ‘Password’ are information for uniquely identifying each viewer.

‘Physical connection information’ includes the router identifier connecting the user terminal and the port identifier of the router, and is determined, for example, when the viewer makes a subscription contract with an Internet service provider (ISP). Conversion server 3 makes an inquiry of this physical connection information determined at the time of the subscription contract with the ISP, etc., and writes the obtained physical connection information into the corresponding field in the viewer information.

‘IP address’ is the IP address of the user terminal. With regard to the assignment of this IP address, there are two cases. One is that a fixed address is assigned in advance, and the other is that an address is assigned each time the user terminal accesses the communication network. Accordingly, in the former case, the pre-assigned address is written into this IP address field. In the latter case, because the address changes dynamically access by access, the IP address field is left blank (for example, a character string such as ‘Null’ is written.).

‘Ticket purchase number’ and ‘password proper to the ticket purchase number’ are issued by control unit 31 of conversion server 3 when the service reservation is completed, and may be for use in authenticating the viewer when cancellation of the reservation is requested.

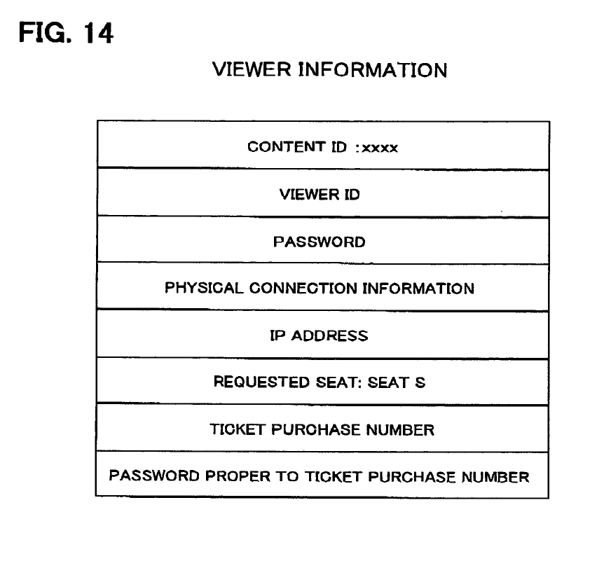

After such content information and viewer information are created, immediately before the content distribution time (i.e. the start time of the live broadcast), conversion server 3 creates policy data necessary for setting the communication network. Namely, control unit 31 in conversion server 3 manages start date/time of the content information by use of a timer, etc. When the time comes near the start time of the live broadcast (for example, an hour before the start time, thirty minutes before the start time, or the like), control unit 31 instructs conversion unit 32 to process the corresponding content information and viewer information. On receipt of this instruction, conversion unit 32 starts the processing for converting the content information and viewer information to the policy data. FIG. 15 shows a flowchart illustrating the conversion processing converting from the content information and viewer information to the policy data.

First, conversion unit 32 reads out the corresponding content information (refer to FIG. 7) from storage unit 33 (step 31). Next, conversion unit 32 selects one viewer ID among the viewers belonging to the viewer ID group in the content information having been read out (S2). Next, conversion unit 32 reads from storage unit 33 the viewer information (refer to FIG. 14) corresponding to the selected viewer ID (S3).

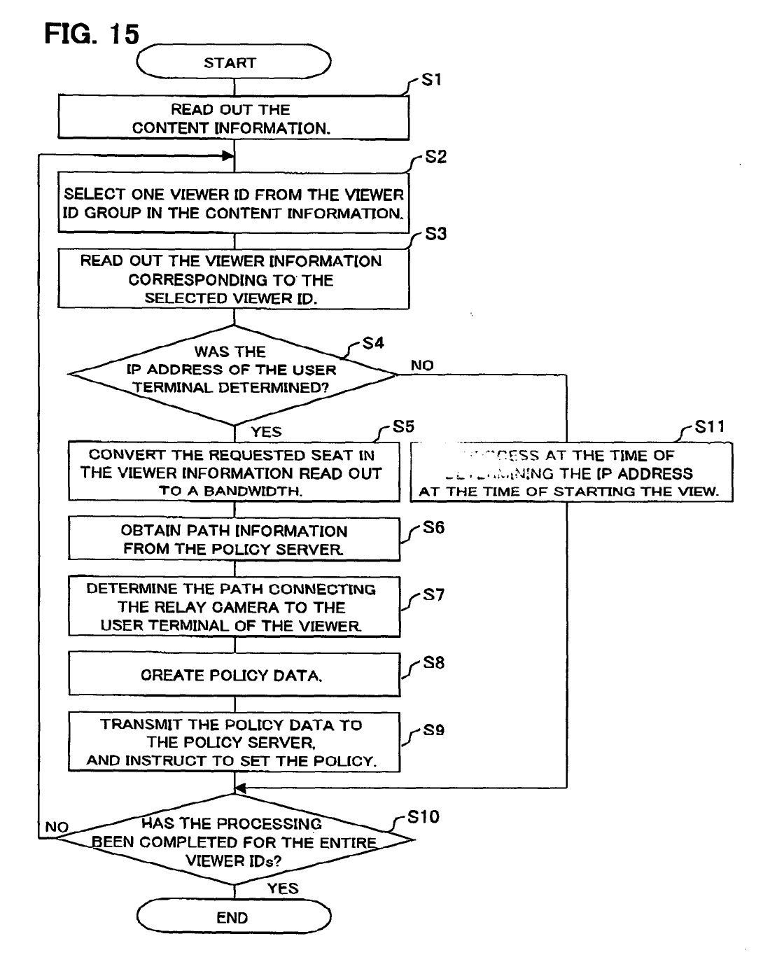

Subsequently, conversion unit 32 decides whether or not the readout viewer information has an IP address having been determined (S4). As mentioned earlier, when the IP address of the user terminal has been determined, the IP address has already been written in the IP address field, whilst the IP address field is left blank when the IP address is not determined yet. Accordingly, conversion unit 32 checks whether any IP address has already been written in the IP address field. If the address has been written (Yes in S4), conversion unit 32 converts the requested seat stored in the viewer information into the corresponding bandwidth by use of the real entity versus bandwidth information stored in storage unit 33 (S5) FIG. 16 shows an example of the real entity versus bandwidth information.

The real entity versus bandwidth information specifies the relation of correspondence between the bandwidths and the real entities mapped in the man-machine interface for service input. In this example, the following relation is specified: Bandwidth of 6 Mbps is assigned for the seat S, 1 Mbps is assigned for the seat A, and the ‘best effort’ is assigned for the seat B.

Next, conversion unit 32 obtains path information (refer to FIG. 2) from policy server 2 (S6). Conversion unit 32 then determines the path for connecting relay camera 4 with the user terminal of the viewer based on the path information obtained above, the physical connection information stored in the content information, and the physical connection information stored in the viewer information (S7).

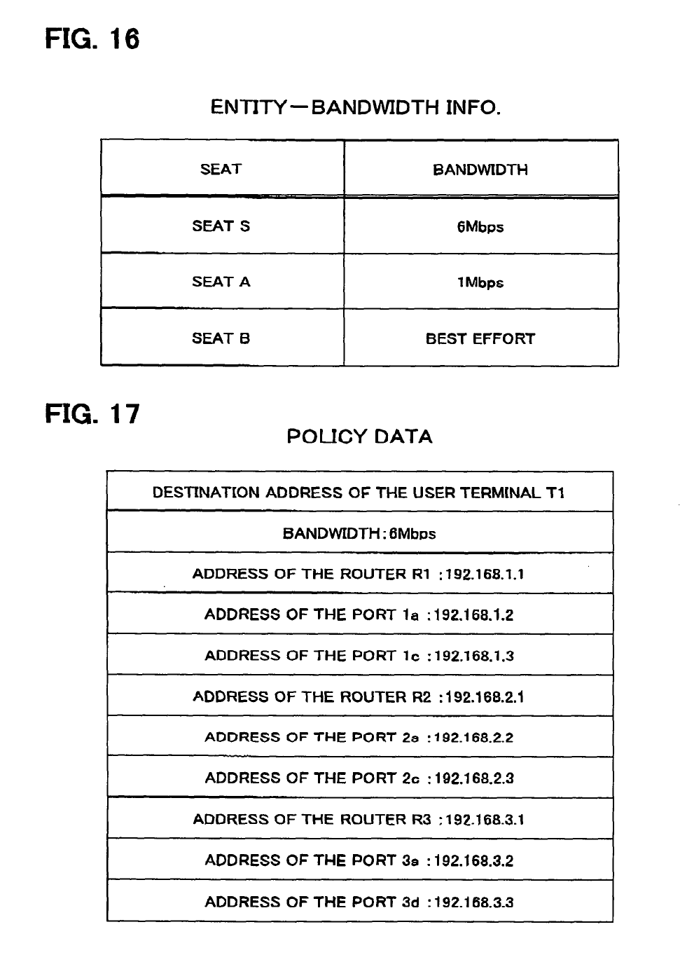

Subsequently, conversion unit 32 creates the policy data (S8). FIG. 17 shows an example of the policy data. There is shown an exemplary policy data related to the path #1 for connecting relay camera 4 with user terminal T1. The policy data includes the destination address (IP address) of the user terminal, the bandwidth secured along the path, the router addresses (IP addresses) existent on the path, and the port addresses (IP addresses) of these routers.

‘Destination address of the user terminal’ is the IP address stored in the viewer information (the IP address of the user terminal T1 in FIG. 17). ‘Bandwidth’ is the bandwidth converted from the requested seat in the viewer information based on the real entity versus bandwidth information. In FIG. 17, the bandwidth is set as 6 Mbps corresponding to the seat S. ‘Router addresses’ existent on the path and ‘port addresses’ of these routers are obtained from policy server 2.

After creating the policy data, conversion unit 32 stores the policy data into storage unit 33, and also reports the completion of creating the policy data to control unit 31 on receipt of this report, control unit 31 transmits the created policy data to policy server 2, and instructs policy server 2 to set the policy data to each router. Policy server 2 sets the policy data received from conversion server 3 into the corresponding server, and sets the path and the bandwidth between the relay camera and the user terminal.

Thereafter, conversion unit 32 checks whether or not the processing has been completed for the entire viewer IDs belonging to the viewer ID group recorded in the content information (S10). If the processing is not completed for the entire viewer IDs (No in S10), conversion unit 32 selects the next viewer ID (S2), and repeats the processing from step S3 against this selected viewer ID.

Meanwhile, in step S10, when the processing is completed for the entire viewer IDs (Yes in S10), the process in conversion unit 32 is completed.

In step 34, if the IP address of the user terminal has not been determined (No in S4), the IP address of the user terminal is to be determined at the time the user starts to view the broadcast content (as described later). At the time of starting the view, the processing steps shown in steps S5 through 59 are executed, and both the path and the bandwidth are set (S11).

Thereafter, immediately before the start time of the service presentation (live broadcast start time), the viewer who has made the reservation accesses the Web page by specifying the view start URL of conversion server 3. Thus the viewer can start viewing the broadcast content.

By specifying the view screen URL, the aforementioned live broadcast list display screen Q1 shown in FIG. 11 is displayed onto the display unit of the user terminal (assumed as T1). When the viewer clicks and selects the view button of the concert to be viewed, user terminal T1 transmits to conversion server 3 the data indicating the selected concert, together with the data indicating the start of view.

On receipt of these data, control unit 31 in conversion server 3 transmits the view screen corresponding to the selected concert to user terminal T1, and thus the view screen is displayed onto the display unit. FIG. 18 shows a view start screen (live broadcast view acceptance screen) In this live broadcast view acceptance screen, there are provided input fields for inputting the ticket purchase number and the password proper to the ticket purchase number, respectively issued by conversion server 3 at the time of reservation.

When the viewer completes to fill these input fields with the ticket purchase number and the password, and then clicks and selects the view execution button, user terminal T1 transmits the input ticket purchase number and the password to conversion server 3. By comparing the transmitted ticket purchase number and the password with the ticket purchase number and the corresponding password stored in the viewer information, control unit 31 in conversion server 3 authenticates the viewer to confirm the viewer of interest is a regular viewer having reserved the view.

If the viewer of interest is the regular viewer having reserved the view, control unit 31 transmits a view screen (live-broadcast view acceptance completion screen) shown in FIG. 19 to user terminal T1. User terminal T1 then displays this live-broadcast view acceptance completion screen to the display unit. In this live-broadcast view acceptance completion screen, when the viewer clicks and selects the view start button, the images captured by relay camera 4 are transmitted to user terminal T1 through the path set by policy server 2. The transmitted image is then displayed onto the display unit of user terminal T1.

As mentioned earlier, when the IP address of the user terminal is not fixed at the time of reservation, the IP address of this view screen which is used at the time of starting the view is given to conversion server 3. Conversion server 3 then performs the processing following the step 55 shown in FIG. 15, and sets the path and the bandwidth to the routers.

Additionally, in the above description of the embodiment, conversion server 3 is provided independently of policy server 2. However, it may also be possible to configure conversion server 3 integrated with policy server 2. In such a case, conversion server 3 and policy server 2 constitutes a network management system.

Also, in the above description of the embodiment, the concert live broadcast has been exemplified. It may also be possible to apply the present invention to other services, such as a VOD service and services presenting news, TV programs, etc.

As the effects of the present invention, service providers and users who receive services can set and manage a communication network through real entities which are intuitively easy to grasp. This enables easy setting and management of the communication network.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. Network management equipment creating policy data to be set to a configuration element in a communication network system, comprising;
an input section for inputting a network resource required for a network service, which is provided through the communication network system in the form of real entity in a service equivalent to said network service being provided without using the communication network system; and
a conversion section for converting to the network resource the real entity input from the input section, and creating policy data based on said network resource.

2. The network management equipment according to claim 1,
wherein the network service is content distribution service, the network resource is a bandwidth required for distributing the content, the real entity is a seat in a venue when the content is directly viewed in said venue, and a rank or said seat corresponds to a bandwidth size.

3. The network management equipment according to claim 2,
wherein the conversion section retains path information between a distribution source of the content distribution service and a user receiving the content distribution service, or receives said path information from outside equipment, and creates the policy data based on the path information and the bandwidth.

4. The network management equipment according to claim 1,
wherein the input section includes a first input section from which a service provider registers the network service, and a second input section from which a user receiving the network service issues a request for subscribing the service.

5. The network management equipment according to claim 4,
wherein the first input section is so constituted that the service provider can input and register a bandwidth type required for distributing the content in the form of real entity of a seat rank in a venue when the network service is content distribution service.

6. The network management equipment according to claim 4,
wherein the second input section is so constituted that the user receiving the service can input a bandwidth for receiving the content in the form of real entity of a seat rank in the venue when the network service is content distribution service.

7. The network management equipment according to claim 5,
wherein the second input section is 50 constituted that the user receiving the service can input a bandwidth for receiving the content in the form of real entity of a seat rank in the venue when the network service is content distribution service.

8. The network management equipment according to claim 1, further comprising:
an input modification section capable of modifying, in the form of real entity, the network resource having been input from the input section, when modification of said network resource having been input becomes necessary.

9. The network management equipment according to claim 1, further comprising:
a transmission section which transmits the policy data created by the conversion section to a policy server.

10. The network management equipment according to claim 1, further comprising:
a setting section which sets the policy data created by the conversion section to the configuration element of the communication network system.

11. A network management method for creating policy data to be set to a configuration element in a communication network system, comprising:
providing a service provider and a user receiving a network service with man-machine interface for inputting a network resource for a network service, which is provided through the communication network system in the form of real entity in a service equivalent to said network service being provided without using the communication network system;
converting the real entity input through the man-machine interface to the network resource; and
creating policy data for use in a policy server based on the network resource.
